(19) United States
(12) Patent Application Publication
(10) Pub. No.: US 2010/0322284 A1
(43) Pub. Date: Dec. 23, 2010

(54) Method For Determining Power Semiconductor Temperature

(75) Inventors: Charles Lizhi Zhu, Canton, MI (US); Ajay V. Patwardhan, Canton, MI (US); Fred Flett, Indio, CA (US); Matthew R. Obrigkeit, Northville, MI (US)

Correspondence Address: Continental Automotive Systems, Inc.;Patents & Licenses, 21440 W Lake Cook Road, Floor 7, Deer Park, IL, 60010, US

(73) Assignee: CONTINENTAL AUTOMOTIVE SYSTEMS US, INC., Deer Park, IL (US)

(21) Appl. No.: 12/767,038

(22) Filed: Apr. 26, 2010

Related U.S. Application Data
(63) Continuation of application No. 12/144,842, filed on Jun. 24, 2008, now abandoned.
(60) Provisional application No. 60/958,206, filed on Jul. 3, 2007.

(51) Int. Cl. G01K 7/01

(52) U.S. Cl. 374/178; 374/E07.035

(57) ABSTRACT

A method for determining power semiconductor operating temperatures uses a database of measured temperatures. Each temperature is associated with operating conditions and determined by laboratory testing in an environment indicative of operation of the power semiconductors actual operations.

### REFERENCE TO RELATED APPLICATIONS

This application claims priority to U.S. Provisional Application No. 60/958,206 which was filed on Jul. 3, 2007.

### BACKGROUND OF THE INVENTION

This application is directed towards a method of predicting the junction temperature of a power semiconductor.

In the field of power semiconductors it is known that the temperature of the junction has a large impact on the operation of the device relying on the semiconductor, as well as impacting the lifespan of the semiconductor. Exceeding a temperature threshold can cause the junction to rapidly deteriorate and break. Also known in the art is the fact that, due to varied operating conditions, the temperature of the junction is not merely a function of the quantity of electrical power being passed through it.

When using a semiconductor junction in an application which has a widely varied and harsh operating environment (such as a hybrid or electric vehicle), the operating temperature can be greatly affected by the environment. Because the operating temperature has an impact on the life and functionality of a semiconductor junction, it is desirable to provide substantially accurate information regarding the temperature of the semiconductor. Since it is not desirable to include a temperature sensor on each semiconductor junction, it is desirable to develop a method of predicting the temperature of the semiconductor junction.

Known temperature prediction algorithms attempt to account for the operating conditions of the device. In order to predict a temperature, current methods utilize complex and detailed computer simulations which attempt to take the operating conditions into consideration. The output of these simulations is then used to create a database of predicted temperatures which can be utilized by a controller to predict the actual temperature. These simulations are time intensive, and can often result in predictions that differ significantly from the actual running temperatures.

It is therefore desirable to develop a quicker and more accurate method of determining temperature predictions and creating a prediction database.

### SUMMARY OF THE INVENTION

Disclosed is a method for predicting the operating temperature of a semiconductor junction where the operating conditions are checked against a database of expected temperatures and an appropriate temperature is selected and where the database of predicted temperatures is constructed based on test conditions that are substantially similar to real world operating conditions.

These and other features of the present invention can be best understood from the following specification and drawings, the following of which is a brief description.

### BRIEF DESCRIPTION OF THE DRAWINGS

FIG. 1 is a block diagram of an example test setup for performing the described method.

FIG. 2 is a schematic illustration of an example semiconductor junction.

FIG. 3 is a flow chart for a method of creating a prediction database of an embodiment.

FIG. 4 is a schematic illustration of an example hybrid vehicle including a controller utilizing gathered temperature data.

### DETAILED DESCRIPTION OF THE PREFERRED EMBODIMENT

In order to facilitate faster and more accurate predictions of the operating temperature of a semiconductor junction, it is necessary to develop a new apparatus and method for determining the predictions.

A disclosed example method (illustrated in FIG. 1) involves attaching the test semiconductor junction apparatus 50 to a dynamometer 102 in a test bench 104 and recording the temperatures of the semiconductor junction apparatus 50 with the dynamometer 102 producing a torque/speed cycle that would normally be experienced by a semiconductor junction 20 (see FIG. 2) in its intended application. While the dynamometer 102 is operating, the system 100 records the operating temperature of the semiconductor junction apparatus 50. The torque/speed of the dynamometer 102 can be controlled and recorded contemporaneously with the recorded temperature and associated with that temperature. Alternatively, the torque/speed of the dynamometer for each temperature can be determined after the test cycle, based on the torque/speed cycle profile, and achieve the same results.

After the temperature information and the torque/speed cycle information (or other operating information) has been recorded both sets of information arc compiled in a database in the data acquisition unit 110 where each temperature record is associated with at least a specific torque/speed. This can be done by using a timestamp during the initial recordation process, or any other known method of association. Once the temperature data and the torque/speed data (or any other operating conditions desired) are associated with each other it becomes possible to predict the temperature of the semiconductor junction during actual operation by determining the operating conditions and performing a database lookup. This method of determining predictions is significantly more accurate, than the known method of estimating operating conditions, inputting the estimates into a computer algorithm and running a simulation to determine predicted temperatures. Additionally the creation of the predicted temperature database is faster using the above described method than using the computer simulations known in the art.

In order to create above described apparatus it is necessary to develop a sensor system capable of measuring the operating temperature of a semiconductor junction while it was actually operating. FIG. 2 illustrates an apparatus according to an embodiment of the invention where such a measurement is capable. In this embodiment the semiconductor junction 20 has an input 30 and an output 40 which may be connected in a manner as it would be connected in an operating consumer application. The semiconductor junction 20 also has a temperature sensor 10 attached directly to the semiconductor junction. The current of the temperature sensor output is directly proportional to the temperature of the semiconductor junction 20. The temperature sensor 10 output then sends a variable current signal 60 indicating the temperature to a data acquisition unit 110.

The temperature sensor 10 can be attached to the semiconductor junction 20 by placing a unit of thermally conductive and electrically isolative epoxy on the semiconductor junction 20 surface and then placing the temperature sensor on the unit of epoxy. This is then left to dry and once dried, the temperature sensor 10 is affixed to the semiconductor junction 20. Alternatively any other known method of thermally connecting the temperature sensor 10 to the semiconductor junction 20 could be used.

Referring again to FIG. 1, the test bench 104 contains a dynamometer 102, and the apparatus 50, which comprises a temperature sensor 10 and a semiconductor junction 20. The test bench 104 (and consequently the dynamometer 102) is connected to a high voltage DC power supply 106. The DC power supply 106 provides electrical power to the test bench 104 and enables the dynamometer 102 to replicate the torque/speed profile of actual operating conditions of the semiconductor junction 20. The temperature sensor 10 is mounted on the semi conductor junction 20, and then connected through signal wires 60A, 60B to an amplifier 108. The temperature sensor 10 outputs a current signal which is dependent on its temperature, and is sent to the amplifier 108 where it is conditioned to be in a form readable by a data acquisition unit 110. The amplifier 108 additionally is connected to two low voltage independent power sources 112, 114. These power sources 112, 114 facilitate the amplification and conditioning performed in the amplifier 108. Once the current signal has been conditioned to be in a format that can be read by the data acquisition unit 110, it is sent to the data acquisition unit 110. The data acquisition unit 110 records the temperature data in a database for constructing the predicted temperature database.

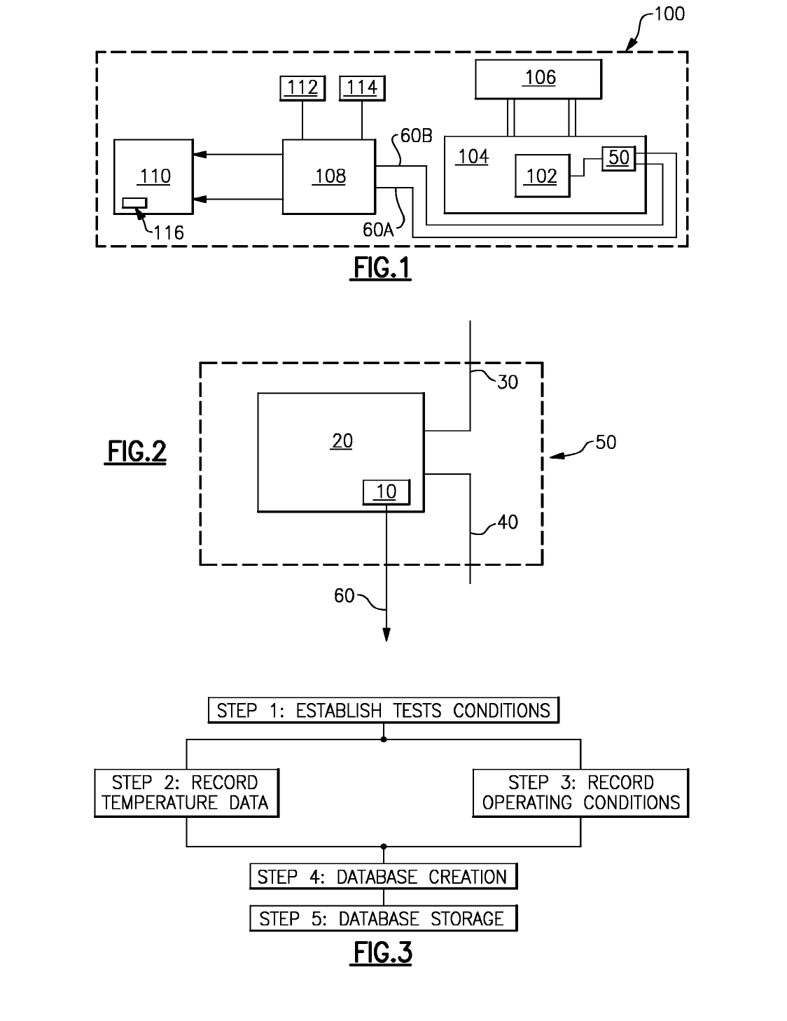

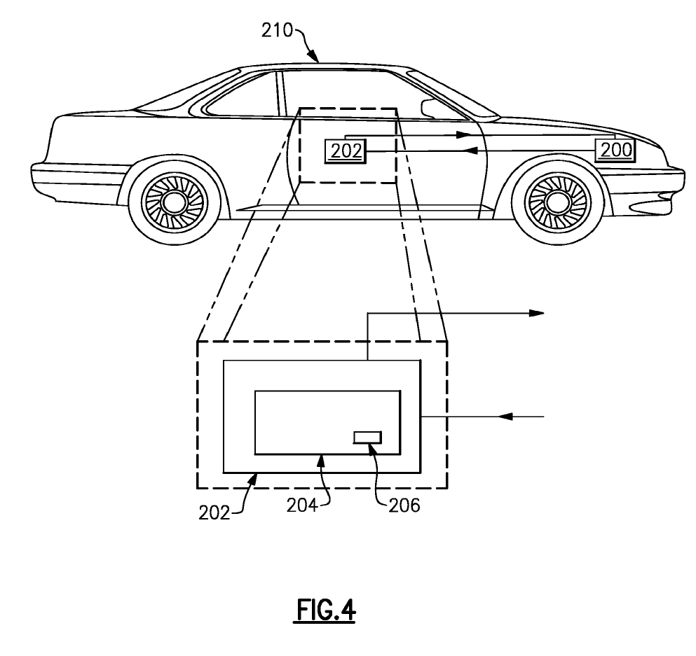

The test bench 104 of this embodiment can be constructed in any manner which would accurately reflect the conditions of an actual consumer unit, such as an electric or hybrid vehicle (FIG. 4) for example. This allows the temperature data recorded by the temperature sensor 10 to be more accurate than a predictive algorithm, as it avoids the problem of attempting to assign a quantifiable value to each potential variable found in the system. The example of FIG. 3 utilizes a dynamometer 102 in the test bench 104, however, it is anticipated that other equipment or additional equipment could be used in the test bench 104 as necessary to simulate the actual operating conditions.

Electromagnetic noise emanating from nearby components can disrupt temperature measurement. The electromagnetic noise typical occurs in the form of high frequency voltage fluctuations, and can result in inaccurate measurements in any system relying on voltage signals. The example temperature sensor 10 is a silicon based temperature transducer which produces a current proportional to the temperature transducer's absolute temperature. Because, the output of the temperature sensor 10 is current based, the output avoids data corruption due to noise caused by voltage fluctuations. In this example an Analog Devices AD950 temperature sensor is used. However, it is known that any sensor capable of avoiding noise and accurately detecting the temperature of a semiconductor junction could be used and still meet the requirements of this disclosure.

FIG. 3 is a flow chart showing an example method for creating a database of predicted temperatures and their associated operating conditions. The method includes the step of establishing test conditions (Step 1). Step 1 includes designing a test system 100 with similar operating conditions to an actual implementation, and then constructing the test system 100 in a testing facility. The example the test conditions simulate conditions encountered during the operation of an electric vehicle. Therefore, the resulting predicted temperatures are based on actual operating temperatures of a test system 100 that is substantially similar to a semiconductor junction as it would be implemented in an electric vehicle or other consumer application.

Temperature data is recorded as indicated at step 2 and involves running the test system and recording the temperature data from the temperature sensor 10. In this step the semiconductor junction 20 is installed in the test system 100 along with the temperature sensor 10. The output from the temperature sensor 10 is recorded in a computer or some other form of memory as the test is run. The recorded temperature data is utilized to create a list of semiconductor junction temperatures related to different operational parameters.

Operating conditions are recorded as indicated at Step 3 simultaneously with the recording temperature data. Information about the specific operating conditions can include (but is not limited to) information about the torque/speed cycle, the ambient air temperature, or any other information indicative of system operating conditions. The test may be designed such that temperature data is taken at predetermined operating conditions. Therefore temperature data is recorded for each of the predetermined operating conditions.

Once Steps 2 and 3 have been performed, a database is created utilizing the temperature and operating condition data as indicated at Step 4. In Step 4, recorded data from steps 2 and 3 is merged into one database. The result of merging the temperature and operating conditions data is a data set that contains a temperature associated with each data point in the set of recorded operating conditions. The association between temperature and operating conditions can be done in any number of ways. One example method includes associating the first temperature to the first operating condition set (determined in step 3). Another example method includes recording a time stamp along with each recordation in steps 2 and 3 and then associating data sets having identical time stamps with each other. As appreciated, other methods of association known in the art arc within the contemplation of this invention. It is also within the contemplation of this method that the procedure of Step 4 may be performed as data is being recorded, thereby reducing the time required for the creation of the prediction database.

After data is compiled in a single database, the database is stored as indicated at step 5. The created database is stored in a data acquisition unit's memory 116 for subsequent transfer to the consumer unit 210. In the consumer unit 210, the temperature prediction database 206 can be stored in controller memory 204, or any other accessible memory unit within the consumer unit 210. Once the database 206 is fully installed the final consumer unit 210 can predict the temperature of the semiconductor junction 50 by determining the operating conditions of the semiconductor junction 50, looking up those operating conditions in the database 206, and then reading an associated temperature. The associated temperature is then the predicted temperature, and the controller 202 can respond accordingly.

FIG. 4 illustrates an embodiment of a consumer unit 210 where the database 206 is stored in a controller's 202 memory 204. The controller is connected to a hybrid motor 200 which contains at least one power semiconductor. During the construction or installation of the controller 202, the database 206 is transferred from the data acquisition unit's 110 memory to the controller's 202 memory 304. In the embodiment of FIG. 4 the consumer unit 210 is a hybrid car, although it is anticipated that any application utilizing power semiconductor junctions could employ this technique as well.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of determining semiconductor junction temperatures comprising:
creating a database of determined semiconductor junction temperatures by measuring a semiconductor's junction temperature during test conditions at least substantially similar to actual operating conditions of a device in which said semiconductor could be used;
associating information contained in the database with a set of designated operating conditions of the device;
storing said database and said associated information on a controller; and
said controller further containing instructions for receiving actual operating conditions of said device and determining a temperature corresponding to said actual operating conditions based on information in said database.

2. The method of claim 1 wherein said step of creating a database of semiconductor junction temperatures comprises operating said semiconductor junction in a test environment where said test conditions are similar to actual operating conditions.

3. The method of claim 2 comprising the additional steps of:
attaching a temperature sensor to a semiconductor junction; and
recording an output of said temperature sensor indicative of a temperature of said semiconductor junction.

4. The method of claim 3 wherein said temperature sensor comprises a silicon based temperature sensor.

5. The method of claim 3 wherein said temperature sensor output comprises a current based data signal.

6. The method of claim 3 wherein said step of attaching a temperature sensor comprises:
placing a unit of thermally conductive and electrically isolative epoxy on an emitter surface of said semiconductor junction; and
mounting said temperature sensor to said emitter surface of said semiconductor junction using said unit of epoxy.

7. The method of claim 2 comprising the additional steps of:
recording said test conditions throughout the test; and
associating an output of a temperature sensor with said recorded test conditions.

8. An apparatus for creating a database of semiconductor junction temperatures comprising:
a test bench capable of producing operating conditions replicating operating conditions of a desired device;
a semi-conductor connected to said test bench;
a temperature sensor thermally connected to said semi-conductor junction; and
a temperature sensor output electrically connected to a data acquisition unit.

9. The device of claim 8 wherein said temperature sensor is constructed at lest partially out of silicon.

10. The device of claim 8 wherein said apparatus additionally comprises:
an epoxy-based adhesive connecting said temperature sensor to said semiconductor junction.

11. The device of claim 8 wherein said apparatus additionally comprises:
a wirebond connection connecting said temperature sensor with at least one signal wire; and
said signal wire connecting to said data acquisition unit.

12. The device of claim 11 wherein said signal wire connects to an amplifier capable of conditioning a signal prior to said connection to said data acquisition unit.

13. The device of claim 8 wherein said test bench comprises at least a dynamometer.

14. The device of claim 13 wherein said dynamometer is capable of producing a torque/speed cycle replicating a torque/speed cycle which would occur in a hybrid vehicle.

15. The device of claim 13 wherein said dynamometer is capable of producing a torque/speed cycle replicating a torque/speed cycle which would occur in an electric vehicle.
